(19) United States
(12) Patent Application Publication
(10) Pub. No.: US 2026/0324637 A1
(43) Pub. Date: Oct. 22, 2026

(54) MATERIALS AND METHODS FOR MODULATING PLANT GROWTH AND RESPONSES TO STRESS

(71) Applicant: REMOTE EPIGENETICS INC., ENCINITAS, CA (US)

(72) Inventors: PAUL ZORNER, ENCINITAS, CA (US); TOM GUDA, ENCINITAS, CA (US)

(21) Appl. No.: 19/644,536

(22) Filed: Apr. 10, 2026

Related U.S. Application Data
(60) Provisional application No. 63/787,371, filed on Apr. 11, 2025.

(51) Int. Cl. A01N 43/08; A01N 25/12; A01N 37/06; A01N 65/22; A01P 13/00

(52) U.S. Cl. CPC A01N 43/08; A01N 25/12; A01N 37/06; A01N 65/22; A01P 13/00

(57) ABSTRACT

The subject invention pertains to compositions that can be used in methods of treating plants to alter or delay development of a plant tissue, alter or delay response to abiotic stress or infection in a plant, alter the flavor chemical profile of plant tissues, desiccate a plant and/or kill a plant.

### CROSS-REFERENCE TO A RELATED APPLICATION

This application claims priority to U.S. Provisional Patent Application No. 63/787,371, filed Apr. 11, 2025, which is incorporated herein by reference in its entirety.

### BACKGROUND OF THE INVENTION

Humans and other animals rely on plants and plant products as sources of nutrition, as well as a wide range of other products such as wood and fiber. Efforts have been made to increase the yield of crops and improve plants' characteristics against environmental challenges. There is a continual need for increasing the quantity, and improving the quality, of food and other crops.

Crops face a multitude of stresses that can significantly impair their growth, development, and productivity. These stresses can be categorized into abiotic and biotic factors, each posing unique challenges to agricultural systems. Abiotic stresses encompass environmental conditions such as drought, salinity, cold, and extreme temperatures, while biotic stresses arise from living organisms, including insects, pathogens, and competing plants. Understanding these stresses and the plant signaling pathways that respond to them is crucial for developing resilient crop varieties that can thrive in increasingly variable climates and challenging ecosystems.

Biotic stress refers to the negative impacts on plants caused by living organisms, including insects, fungi, bacteria, viruses, and competing plants. These stresses can lead to reduced growth, diminished yields, and even plant mortality, making their management crucial for agricultural sustainability.

The protection of crop plants (crops) from weed plants (weeds) and other unwanted vegetation which inhibit crop growth is a constantly recurring problem in agriculture. To help combat this problem, researchers in the field of synthetic chemistry have produced an extensive variety of active herbicidal ingredients (herbicides) and formulations effective in the control of such unwanted growth and for use as crop harvesting aids. Herbicides of many structural types and with different modes of action have been disclosed in the literature and a large number are in commercial use.

### BRIEF SUMMARY OF THE INVENTION

The subject invention pertains to the use of active compounds in methods of altering, inter alia, plant health and growth.

In certain embodiments, the compositions and methods of the subject invention can be used to kill a plant or plant tissue.

Advantageously, the methods and compositions of the subject invention can increase the efficiency and reduce the financial and environmental costs of agriculture practices.

### BRIEF DESCRIPTION OF THE DRAWING

FIG. 1 is a photograph depicting the effects of compounds according to embodiments of the subject invention on plant health and/or growth compared with controls. A key is also provided, which depicts the treatments that were applied to each plant as indicated by treatment codes corresponding to compounds in Table 3.

### DETAILED DESCRIPTION OF THE INVENTION

The subject invention pertains to the use of active compounds in methods of altering, inter alia, plant health and growth. In certain embodiments, the active compound can enter target plant tissues, such as, for example, a primary root, secondary root, leaf, stem, fruit, flower, seed, or any combination thereof. In certain embodiments, an active compound can enter a target fungus tissue, such as, for example, in the cap, gills, stem, or any combination thereof.

In certain embodiments, the compositions and methods of the subject invention can be used to kill a plant or plant tissue.

In certain embodiments, the compositions and methods of the subject invention can be used to as a pre-harvest desiccant to assist in harvest efficiency and support harvested crop quality.

In certain embodiments, the compositions and methods of the subject invention can be used to alter or delay development of a plant's response to abiotic stress or infection, and/or alter the flavor chemical profile or medicinal chemical profile of plant tissue.

In certain embodiments, the flavor chemical profile of a plant tissue can be altered by altering the level of fructose, flavor compounds, medicinal compounds or other metabolites, which can be determined using chromatographic techniques and standard metabolomics methods, including, for example, gas chromatogram linked mass spectrometry.

### Selected Definitions

As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising”. The transitional terms/phrases (and any grammatical variations thereof) “comprising”, “comprises”, “comprise”, “consisting essentially of”, “consists essentially of”, “consisting” and “consists” can be used interchangeably. Unless specifically stated or obvious from context, as used herein, the term “or” is understood to be inclusive.

The phrases “consisting essentially of” or “consists essentially of” indicate that the claim encompasses embodiments containing the specified materials or steps and those that do not materially affect the basic and novel characteristic(s) of the claim.

The term “about” means within an acceptable error range for the particular value as determined by one of ordinary skill in the art, which depends in part on how the value is measured, i.e., the limitations of the measurement system. In the context of compositions containing amounts of ingredients where the terms “about” are used, these compositions contain the stated amount of the ingredient with a variation (error range) of 0-10% around the value (X±10%). In other contexts, the term “about” is providing a variation (error range) of 0-10% around a given value (X±10%). As is apparent, this variation represents a range that is up to 10% above or below a given value, for example, X±1%, X±2%, X±3%, X±4%, X±5%, X±6%, X±7%, X±8%, X±9%, or X±10%.

In the present disclosure, ranges are stated in shorthand to avoid having to set out at length and describe each and every value within the range. Any appropriate value within the range can be selected, where appropriate, as the upper value, lower value, or the terminus of the range. For example, a range of 0.1-1.0 represents the terminal values of 0.1 and 1.0, as well as the intermediate values of 0.2, 0.3, 0.4, 0.5, 0.6, 0.7, 0.8, 0.9, and all intermediate ranges encompassed within 0.1-1.0, such as 0.2-0.5, 0.2-0.8, 0.7-1.0, etc. Values having at least two significant digits within a range are envisioned, for example, a range of 5-10 indicates all the values between 5.0 and 10.0 as well as between 5.00 and 10.00 including the terminal values. When ranges are used herein, combinations and subcombinations of ranges (e.g., subranges within the disclosed range) and specific embodiments therein are explicitly included.

As used herein, the term “control” in the context of a pest means killing, disabling, immobilizing or otherwise rendering the pest substantially incapable of reproducing and/or causing harm.

As used herein, “derivative” means any compound that can be imagined to arise from another compound, if one atom or group of atoms is replaced with another atom or group of atoms. Stated differently, the term “derivative” means a structural analog.

As used herein, “reduction” refers to a negative alteration, and the term “increase” refers to a positive alteration, wherein the negative or positive alteration is at least 0.25%, 0.5%, 1, 5%, 10%, 15%, 20%, 25%, 30%, 35%, 40%, 45%, 50%, 55%, 60%, 70%, 75%, 80%, 85%, 90%, 95%, or 100%.

As used herein “preventing” or “prevention” of a situation or occurrence means delaying, inhibiting, suppressing, forestalling, and/or minimizing the onset, extensiveness or progression of the situation or occurrence. Prevention can include, but does not require, indefinite, absolute or complete prevention, meaning it may still develop at a later time. Prevention can include reducing the severity of the onset of such a situation or occurrence, and/or stalling its development to a more severe or extensive situation or occurrence.

As used herein, “enhancing” means improving or increasing. For example, enhanced plant development means improving the plant's ability grow and thrive, which includes increased seed germination and/or emergence, and improved ability to survive environmental stressors, such as droughts and/or flooding. Enhanced plant development and/or enhanced plant biomass means increasing the size and/or mass of a plant above and/or below the ground (e.g., increased canopy/foliar volume, height, trunk caliper, branch length, shoot length, protein content, root size/density and/or overall growth index), and/or improving the ability of the plant to reach a desired size and/or mass. Enhanced yields mean improving the end products produced by the plants in a crop, for example, by increasing the number and/or size of fruits, leaves, roots and/or tubers per plant, and/or improving the quality of the fruits, leaves, roots and/or tubers (e.g., improving taste, texture, brix, chlorophyll content and/or color).

As used herein, “abiotic stress” refers to any non-living factor that can negatively impact a living organism in a specific environment, such as, for example, drought, salinity, flooding and low or high temperatures.

As used herein, an “environmental signal” refers to an environmental variable that influences plant growth, development and adaptation, often eliciting alteration in, for example, gene expression, protein activity and metabolic processes in plants. Environmental signals can include, but are not limited to, for example, day length, temperature, water availability, nutrient availability, gravity, wind, or chemicals.

As used herein, “agriculture” means the cultivation and breeding of plants for food, fiber, biofuel, medicines, cosmetics, supplements, ornamental purposes and other uses. According to the subject invention, agriculture can also include horticulture, landscaping, gardening, plant conservation, forestry and reforestation, pasture and prairie restoration, ranching, dairy production, orcharding, arboriculture, and agronomy. Further included in agriculture are the care, monitoring and maintenance of soil.

As used herein, “farmland” includes any tract of land in which plants are grown, cultivated and/or managed for human interests. Farmland includes: pastures, or land containing mostly grasses, legumes and non-grass herbaceous plants, that is grazed by livestock; meadows, which are typically ungrazed tracts of land that may be used for harvesting hay or other animal fodder; rangelands, which include untended and human-tended grasslands, shrublands, woodlands, wetlands and deserts that are grazed by domestic livestock or wild animals; and agricultural crops.

As used herein, “agricultural crops,” “crop plants,” or “cash crops” refer to any species of plant or alga, grown for profit and/or for sustenance for humans, animals or aquatic organisms, or used by humans (e.g., textile, cosmetics, and/or drug production), or viewed by humans for pleasure (e.g., flowers or shrubs in landscaping or gardens) or any plant or alga, or a part thereof, used in industry, commerce or education. Crop plants can be plants that can be obtained by traditional breeding and optimization methods or by biotechnological and recombinant methods, or combinations of these methods, including the transgenic plants and the plant varieties.

As used herein, a “soil amendment” or a “soil conditioner” is any compound, material, or combination of compounds or materials that are added into soil to enhance the properties of the soil. Soil amendments can include organic and inorganic matter, and can further include, for example, fertilizers, pesticides and/or herbicides. Nutrient-rich, moist, low saline, microbially-rich, appropriate soil organic carbon, well-draining soil is essential for the growth and health of plants, and thus, soil amendments can be used for enhancing the plant biomass by altering the nutrient, salinity, microbial content soil organic carbon content, and moisture content of soil. Soil amendments can also be used for improving many different qualities of soil, including but not limited to, soil structure (e.g., aggregate content and preventing compaction); improving the nutrient concentration and storage capabilities; improving water retention in dry soils; and improving drainage in waterlogged soils.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

All references cited herein are hereby incorporated by reference in their entirety.

### Active Compositions

In certain embodiments, the subject invention provides compositions comprising compounds that can be used in methods of treating plants and/or fungi to, for example, alter or delay development of a plant or fungal tissue, alter or delay response to abiotic stress or infection in a plant and/or fungus, alter the flavor chemical profile of plant and/or fungal tissues, and/or kill a plant and/or fungus.

In certain embodiment, the compositions of the subject invention comprise 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, or more compounds. The compounds can be, for example, lactones, formates, aromatic ester derivatives, phenylpropanoid esters, chalcone-like compounds, polyphenolic flavonoid derivatives, straight-chain fatty acids, polyhydroxylated aromatic/carbohydrate (glycoside) structures, cresyl salicylate derivatives, benzyl and/or cinnamyl benzoates, benzyl derivatives, benzyl and phenyl-substituted salicylates, anthranilate derivatives, phenethyl and cinnamyl acetate derivatives, cinnamate esters, and/or valerate derivatives.

In certain embodiments, the compounds are selected from the categories of compounds listed in Table 1, including any combination thereof.

TABLE 1
Representative categories of active compounds

| General | | | | |
|---|---|---|---|---|
| Formula | | | | |
| No. | Category | Core Structure | R groups | Non-limiting Examples |
| 1 | Lactones | 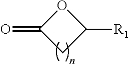 n = integer ≥ 1 | R¹ = c.g., H; halogens (F, Cl, Br, I); hydroxyl, alkyl, vinyl and/or aryl groups. In some embodiments, one or more saturated bonds may be substituted with unsaturated bonds within the carbon ring. | Gamma lactones Delta lactones Epsilon lactones |
| 2 | Lactones | 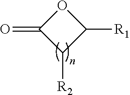 n = integer ≥ 1 | R¹ and R² = e.g., H; halogens (F, Cl, Br, I); hydroxyl, alkyl, vinyl and/or aryl groups. In some embodiments, one or more saturated bonds may be substituted with unsaturated bonds within the carbon ring. | Gamma lactones Delta lactones Epsilon lactones |
| 3 | Gamma lactones (5- membered lactones) | 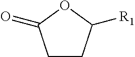 | R¹ = e.g., H; halogens (F, Cl, Br, I); various alkyl groups (CₙH₂ₙ₊₁, where n = integer ≥ 1). | Gamma-valerolactone Gamma-butyrolactone Gamma-octalactone Gamma-nonalactone |
| 4 | Delta lactones (6-membered lactones) | 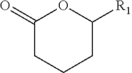 | R¹ = e.g., H, halogens (F, Cl, Br, I) and/or various alkyl groups (CₙH₂ₙ₊₁, where n = integer ≥ 1). | Delta-decalactone Delta-octalactone Delta-hexalactone Delta-undecalactone |
| 5 | Epsilon lactones (7-membered lactones) | 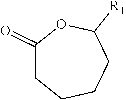 | R¹ = e.g., H, halogens (F, Cl, Br, I) and/or various alkyl groups (CₙH₂ₙ₊₁, where n = integer ≥ 1). | Caprolactone 7-methylcaprolactone |
| 6 | Formates | 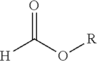 | R = halogens (F, Cl, Br, I), alkyl, cycloalkyl, allyl, benzyl and/or phenyl-based groups. | Alkyl formates, such as, e.g., methyl formate, ethyl formate, propyl formate, isopropyl formate, butyl formate, sec-butyl formate, iso-amyl formate, hexyl formate, octyl formate and decyl formate; Unsaturated alkyl formates, such as, e.g., allyl formate, vinyl formate, (E/Z)-hezenyl formate and prenyl formate; Cycloalkyl formates, such as, e.g., cyclohexyl formate, cyclooctyl formate and cyclodecyl formate; and Aromatic or benzyl formates, such as, e.g., benzyl formate, phenethyl formate and cinnamyl formate (E/Z). |
| 7 | Aromatic ester derivatives (benzoates, salicylates & cinnamates) | R¹—O—CO—Ar—R² 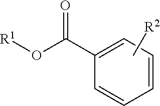 | R¹ = halogens (F, Cl, Br, I), benzyl, phenethyl, cinnamyl and/or alkyl. Ar = phenyl R² = halogens (F, Cl, Br, I), OH, OCH₃, alkyl and/or H. | Phenyl salicylate |
| 8 | Phenyl- propanoid esters | R¹—Ph—CH═CH—CH₂—O—CO—R² 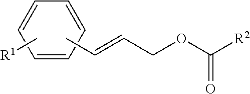 | R¹ = OCH₃, OH, halogens (F, Cl, Br, I), and/or alkyl. R² = acetate, butyrate, benzoate, and/or halogens (F, Cl, Br, I). | Isoeugenol acetate |
| 9 | Chalcone-like compounds | R¹—Ar¹—CH═CH—CO—Ar²—R² 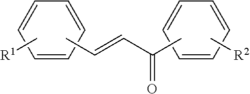 | R¹ and R² = OH, OCH₃, halogens (F, Cl, Br, I), and/or an aromatic. Ar¹ and Ar² = phenyl rings | Dehydrozingerone |
| 10 | Polyphenolic and/or flavonoid derivatives | 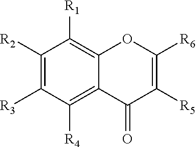 | R¹⁻⁶ = H, OH, OCH₃, halogens (F, Cl, Br, I), and/or prenyl groups. | Acacetin |
| 11 | Straight-chain fatty acids | CH₃—(CH₂)ₙ—COOH 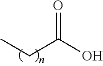 n = integer ≥ 1, e.g., 2 to 18 | | Palmitic acid |
| 12 | Polyhydroxy- lated aromatics/ carbohydrates (glycosides) | 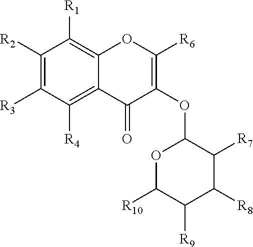 | R¹⁻¹⁰ = halogens (F, Cl, Br, I), glycoside sugars and/or OH. | Myrictrin |
| 13 | Cresyl salicylate derivatives | R¹—C₆H₄—O—CO—C₆H₄—OH 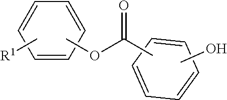 | R¹ = halogens (F, Cl, Br, I), para-cresyl (4-CH₃—Ph), ortho-cresyl (2-CH₃—Ph), phenethyl (—CH₃—CH₂—Ph), guaiacyl (2- methoxyphenyl), prenyl (3-methylbut-2-en-1- yl), 2-methylbutyl and/or 3- phenylpropyl. | Para-cresyl salicylate Ortho-cresyl salicylate Meta-cresyl salicylate Phenyl salicylate Phenethyl salicylate Guaiacyl salicylate Prenyl salicylate 2-methyl butyl salicylate 3-phenyl propyl salicylate |
| 14 | Benzyl and/or cinnamyl benzoates | R¹—CH₂—O—CO—C₆H₅ 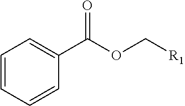 | R¹ = halogens (F, Cl, Br, I), benzyl (Ph—CH₂) and/or cinnamyl (3-phenylprop-2- enyl). | Benzyl benzoate Cinnamyl benzoate Benzyl phenyl carbinol Benzyl para-anisate Benzyl valerate Benzyl nicotinate |
| 15 | Benzyl derivatives | C₆H₅—CH₂—O—CO—R¹ 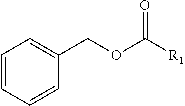 | R¹ = halogens (F, Cl, Br, I), nicotinic acid (3- pyridinecarboxylic acid), levulinic acid (4- oxopentanoic acid) and/or phenylcarbinol (Ph—CH— OH). | Benzyl nicotinate Benzyl anthranilate Benzyl levulinate Benzyl eugenol |
| 16 | Salicylate esters | R¹—CH₂—O—CO—C₆H—OH 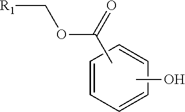 | R¹ = halogens (F, Cl, Br, I), benzyl (Ph—CH₂), guaiacyl (2-methoxyphenyl), isoamyl (3-methylbutyl), prenyl (3- methylbut-2-enyl), phenyl, cinnamyl (Ph—CH═CH— CH₂—), phenethyl (Ph—CH₂— CH₂—) and/or alkyl/alkenyl groups (e.g., butyl, hexyl, allyl). | Benzyl salicylate Guaiacyl salicylate Prenyl salicylate Phenyl salicylate Ortho-cresyl salicylate Phenethyl salicylate Cinnamyl salicylate Isoamyl salicylate Butyl salicylate Hexyl salicylate Allyl salicylate 2-methyl butyl salicylate 3-phenyl propyl salicylate |
| 17 | Anthranilate | R¹—O—CO—C₆H₄—NH₂ 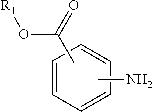 | R¹ = halogens (F, Cl, Br, I), benzyl (Ph—CH₂), phenethyl (Ph—CH₂—CH₂—), isoamyl (3-methylbutyl) and/ or amyl (pentyl). | Benzyl anthranilate Phenethyl anthranilate Isoamyl anthranilate Amyl anthranilate |
| 18 | Phenethyl and/or cinnamyl acetate derivatives | R¹—O—CO—CH₃ 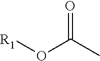 | R¹ = halogens (F, Cl, Br, I), cinnamyl (Ph—CH═CH— CH₂—), phenethyl (Ph—CH₂— CH₂—) and/or other related phenylalkyl substituents. | Cinnamyl acetate Phenethyl benzoate Phenethyl acetate Phenethyl propanoate Phenethyl lactate Phenethyl sorbate Phenethyl resorcinol |
| 19 | Cinnamate esters | R¹—O—CO—CH═CH—C₆H₅ 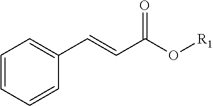 | R¹ = halogens (F, Cl, Br, I), ethyl, benzyl (Ph—CH₂), cinnamyl (Ph—CH═CH— CH₂—), butyl, hexyl, straight-chain alkyl groups. | Ethyl (E)-cinnamate Cinnamyl acetate Cinnamyl benzoate Cinnamyl cinnamate |
| 20 | Valerate derivatives | R¹—O—CO—(CH₂)₃—CH₃ 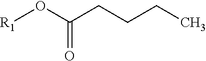 | R¹ = halogens (F, Cl, Br, I), benzyl (Ph—CH₂) and/or cinnamyl (Ph—CH═CH— CH₃). | Benzyl valerate |

In certain embodiments, the compounds are selected from the compounds listed in Table 2, including any combination thereof.

TABLE 2
Active Compounds

(E)-2-hexen-1-yl phenyl acetate
(E)-2-hexen-1-yl salicylate
(E)-3-butylidene phthalide
(E)-3-hexen-1-yl benzoate
(E)-cinnamyl acetate
(E)-cinnamyl butyrate
(E)-cinnamyl propionate
(R)-benzoin
(R)-delta-undecalactone
(S)-benzoin
(Z)-2-penten-1-yl benzoate
(Z)-3-hexen-1-yl anisate
(Z)-3-hexen-1-yl anthranilate
(Z)-3-hexen-1-yl cinnamate
(Z)-3-hexen-1-yl salicylate
(Z)-anisylidene acetone
(Z)-N-Coumaroyl-5-hydroxyanthranilic acid
\1,3-dimethyl-3-butenyl salicylate\
\2,5-distyryl pyrazine\
\3′,7-dihydroxy-4′-methoxyflavan\
\alpha, alpha-dimethyl anisyl acetone\
1-(2-hydroxy-4-methoxyphenyl)-3-(pyridin-2-yl)propan-1-one
1-(2-hydroxyphenyl)-3-(pyridin-4-yl)propan-1-one
1-(2-phenyl ethoxy)-2-(4-methyl phenoxy)ethanol
1-(4-Methoxyphenyl)-1-penten-3-one
1,3-Diphenyl-2-propanone
2-(2-phenyl ethyl) chromone
2-(Phenylethenyl)-1,3-dioxolane
2,5-Dimethyl-1,4-dithiane-2,5-diol
2-hydroxyethyl phenoxyacetate
2-isopropoxyethyl salicylate
2-Methoxy-4-methylphenol
2-Methoxy-4-propylphenol
2-Methoxybenzaldehyde
2-Methoxybenzyl acetate
2-methyl butyl benzoate
2-methyl butyl salicylate
2-Methyl-3-phenylpropanal
2-Methyl-3-phenylpropionic acid
2-Methylbenzyl acetate
2-naphthyl phenyl ketone
2-para-cresyl oxyethyl acetate
2-phenoxyethyl formate
2-Phenylethyl 2-aminobenzoate
2-Phenylethyl 2-furancarboxylate
2-Phenylethyl 3-methyl-2-butenoate
2-Phenylethyl 3-phenyl-2-propenoate
2-Phenylethyl acetate
2-Phenylethyl benzoate
2-Phenylethyl hexanoate
2-Phenylethyl pentanoate
2-Phenylethyl propanoate
2-Propenyl 2-aminobenzoate
3-(2-Furanyl)-2-phenyl-2-propenal
3-methyl dibenzothiophene
3-methyl-3-buten-1-yl benzoate
3-Methylthiophene
3-phenyl propyl benzoate
3-phenyl propyl cinnamate
3-phenyl propyl crotonate
3-phenyl propyl salicylate
3-Phenylpropionic acid
4-dihydromethyl-2H-pyran-2-yl guaiacol
4-formyl phenyl butyrate
4-Methoxybenzyl phenylacetate
4-Methylphenyl 3-methylbutanoate
4-phenyl propyl pyridine
9-Octadecenoic acid, 12-hydroxy-, monopotassium salt,
(9Z, 12R)-
Acacetin
acetaminosalol
allyl (Z)-cinnamate
Allyl phenoxyacetate
allyl salicylate
alpha-Cyclodextrin
amyl anthranilate
amyl cinnamate
Amyl phenylacetate
Amyl salicylate
annatto seed extract (solvent-extracted bixin)
annatto seed extract (solvent-extracted norbixin)
annatto seed powder
aromadedrin
Benzaldehyde, 4-hydroxy-3-methoxy-
Benzoin
benzoyl anthranilic acid
Benzoyl peroxide
benzyl (E)-crotonate
benzyl (E)-isoeugenol
Benzyl 2,3-dimethyl-2-butenoate
Benzyl 2-methylbutanoate
benzyl anthranilate
Benzyl Benzoate
Benzyl butyrate
benzyl eugenol
benzyl levulinate
benzyl nicotinate
benzyl para-anisate
benzyl phenyl carbinol
benzyl salicylate
Benzyl trans-2-methyl-2-butenoate
benzyl valerate
bergamottin
Bergaptol
beta-naphthyl anthranilate
beta-naphthyl benzoate
Bisdemethoxycurcumin
butyl 2-naphthyl ether
butyl anthranilate
butyl cinnamate
butyl para-anisate
butyl salicylate
Butylparaben
Caffeic acid ethyl ester
Caproic Acid
Chalconaringenin
Chalcone
cinnamaldehyde / methyl anthranilate schiff′s base
cinnamaldehyde butylene glycol acetal
cinnamyl 2-methyl butyrate
Cinnamyl acetate
cinnamyl acetoacetate
cinnamyl anthranilate
Cinnamyl benzoate
Cinnamyl butyrate
cinnamyl cinnamate
cinnamyl eugenol
cinnamyl hexanoate
cinnamyl phenyl acetate
cinnamyl salicylate
cinnamyl tiglate
cinnamyl valerate
cis-3-Hexenyl benzoate
cis-3-Hexenyl phenylacetate
citral / methyl anthranilate schiff′s base
citrus red 2
cortex pyridine
cuminyl phenyl acetate
curcumin
cyclohexyl cinnamate
Dehydrozingerone
Dextrins
dibenzyl
Dibenzyl ether
diphenethyl ether
eriodictyol
ethyl (E)-cinnamate
Ethyl 3-oxo-3-phenylpropanoate
Ethyl 4-methylphenoxyacetate
Ethyl cinnamate
ethyl para-cresyl carbonate
ethyl phenoxyacetate
eugenyl 2-methyl-2-butenoate
eugenyl acetate
Eugenyl benzoate
eugenyl phenyl acetate
Flavones
furfuryl phenyl acetate
gamma-Cyclodextrin
gamma-Mangostin
geraniol
geranyl acetate
geranyl benzoate
geranyl cantabiline
geranyl cinnamate
geranyl phenyl acetate
guaiacyl benzoate
guaiacyl phenyl acetate
guaiacyl salicylate
heliotropyl phenyl acetate
heraclenol
Herniarin
Hesperetin
hexyl cinnamate
hexyl salicylate
homoeriodictyol
Imperatorin
Irisone B
isoamyl (E)-cinnamate
isoamyl anthranilate
isoamyl p-methoxycinnamate
isoamyl salicylate
isobutyl para-anisate
Isoeugenol
Isoeugenol benzyl ether
isoeugenyl benzoate
isoeugenyl phenyl acetate
Isoimperatorin
Isoquercitrin
ivy carbaldehyde / methyl anthranilate schiff′s base
lactoyl tyramine
Lanolin
lauryl sulfate
linalyl anthranilate
Linalyl cinnamate
linoleic acid
Locust bean gum
Magnesium benzoate
magnolol
malic acid
meta-cresyl benzoate
meta-cresyl phenyl acetate
meta-cresyl phenyl ether
methyl (para-tolyl oxy) acetate
Methyl 2-furoate
methyl phenyl methylene aminobenzoate
Myricitrin
myristic acid
N-benzoylanthranilic acid
neryl anthranilate
neryl cinnamate
NONIVAMIDE
O-geranyl vanillin
oleic acid
ortho-anisyl benzoate
ortho-cresyl benzoate
ortho-cresyl salicylate
Oxypeucedanin hydrate
palmitic acid
palmitoleic acid
para-anisaldehyde / methyl anthranilate schiff′s base
para-anisyl acetoacetate
para-anisyl benzoate
para-anisyl isobutyrate
para-anisyl salicylate
para-cresyl 3-methyl crotonate
para-cresyl 3-oxo-3-phenyl propionate
para-cresyl benzoate
para-cresyl butyrate
para-cresyl hexanoate
para-cresyl phenyl ether
para-cresyl salicylate
para-cresyl valerate
Pentyl benzoate
phellopterin
Phenethyl acetate
Phenethyl butyrate
Phenethyl decanoate
phenethyl lactate
Phenethyl octanoate
phenethyl oxyacetaldehyde
Phenethyl phenylacetate
phenethyl pyridine
phenethyl resorcinol
phenethyl salicylate
phenethyl sorbate
phenethyl tiglate
phenyl acetaldehyde / methyl anthranilate schiff′s base
phenyl propyl phenyl acetate
Phenyl salicylate
Phenylmethyl benzeneacetate
Phloretin
piperine
prenyl salicylate
propyl cinnamate
Psoralen
p-Tolyl phenylacetate
Resveratrol
shikonin
S-methyl thiopropionate
sophoraflavanone B
stearic acid
styryl acetate
Tetradecanoic acid, potassium salt
trilobatin
turmeric root oil vietnam
Valeric acid
Vanillin
Wintergreen oil
xanthohumol

In certain embodiments, the compound, or combination of more than compounds, are selected from the compounds listed in Table 1 and/or Table 2.

In certain embodiments, the compounds used according to the subject invention are not disclosed in WO 2025/059442, which is incorporated herein, in its entirety, by reference.

### Formulations

In certain embodiments, the compound can be applied at a concentration of about 0.000001% to about 10%, about 0.00001% to about 9%, 0.0001% to about 8%, about 0.001% to about 7%, about 0.01% to about 6%, about 0.1% to about 5%, about 0.05% to about 4%, about 0.1% to about 3%, or about 0.5% to about 2% (wt %) with respect to the total weight of the formulation that is applied.

The compositions can be used in combination with other agricultural compounds and/or crop management systems. In one embodiment, the composition can optionally comprise, or be applied with, for example, natural and/or chemical pesticides, repellants, herbicides, fertilizers, water treatments, non-ionic surfactants and/or soil amendments.

If the composition is mixed with compatible chemical additives, the chemicals are preferably diluted with water prior to addition of the subject composition.

In one embodiment, the subject compositions are compatible for use with agricultural compounds characterized as antiscalants, such as, for example, hydroxyethylidene diphosphonic acid; fertilizers, such as, e.g., N-P-K fertilizers, calcium ammonium nitrate 17-0-0, potassium thiosulfate, nitrogen (e.g., 10-34-0, Kugler KQ-XRN, Kugler KS-178C, Kugler KS-2075, Kugler LS 6-24-6S, UN 28, UN 32), and/or potassium; fungicides, such as, for example, chlorothalonil, manicozeb hexamethylenetetramine, aluminum tris, azoxystrobin, Bacillus spp. (e.g., B. lichenformis strain 3086, B. subtilis, B. subtilis strain QST 713), benomyl, boscalid, pyraclostrobin, captan, carboxin, chloroneb, chlorothalonil, copper sulfate, cyazofamid, dicloran, dimethomorph, etridiazole, thiophanate-methyl, fenamidone, fenarimol, fludioxonil, fluopicolide, flutolanil, iprodione, mancozeb, maneb, mefanoxam, fludioxonil, mefenoxam, metalaxyl, myclobutanil, oxathiapiprolin, pentachloronitrobenzene (quintozene), phosphorus acid, propamocarb, propanil, pyraclostrobin, Reynoutria sachalinensis, Streptomyces spp. (e.g., S. griseoviridis strain K61, S. lydicus WYEC 108), sulfur, urea, thiabendazole, thiophanate methyl, thiram, triadimefon, triadimenol, and/or vinclozolin; growth regulators, such as, e.g., ancymidol, chlormequat chloride, diaminozide, paclobutrazol, and/or uniconazole; herbicides, such as, e.g., glyphosate, oxyfluorfen, and/or pendimethalin; insecticides, such as, e.g., acephate, azadirachtin, B. thuringiensis (e.g., subsp. israelensis strain AM 65-52), Beauveria bassiana (e.g., strain GHA), carbaryl, chlorpyrifos, cyantraniliprole, cyromazine, dicofol, diazinon, dinotefuran, imidacloprid, Isaria fumosorosae (e.g., Apopka strain 97), lindane, and/or malathion; adjuvants; surfactants; water treatments, such as, for example, glycolipids, lipopeptides, deet, diatomaceous earth, citronella, essential oils, mineral oils, garlic extract, chili extract, and/or any known commercial and/or homemade pesticide that is determined to be compatible by the skilled artisan having the benefit of the subject disclosure.

The compositions can be formulated in a variety of ways. For example, they can be formulated as a dustable powder, gel, a wettable powder, a water dispersible granule, a water-dispersible or water-foaming tablet, a briquette, an emulsifiable concentrate, a microemulsifiable concentrate, an oil-in-water emulsion, a water-in-oil emulsion, a dispersion in water, a dispersion in oil, a suspoemulsion, a soluble liquid (with either water or an organic solvent as the carrier), an impregnated polymer film, or other forms known in the art. These formulations may be suitable for direct application or may be suitable for dilution prior to application, said dilution being made either with water, liquid fertilizer, micronutrients, biological organisms, oil or solvent. The compositions are prepared by admixing the active ingredient with adjuvants including diluents, extenders, carriers, and conditioning agents to provide compositions in the form of finely-divided particulate solids, granules, pellets, solutions, dispersions or emulsions. Thus, it is believed that the active ingredient could be used with an adjuvant such as a finely-divided solid, a mineral oil, a liquid of organic origin, water, various surface active agents or any suitable combination of these.

The formulations of the invention can comprise the compounds in any suitable concentration. The formulations may also include other fertilizers or pesticides, which may also be present in any suitable concentration.

In one embodiment, the compound can be dissolved in water, organic solvents, or a mixture thereof, without other fertilizers, pesticides, herbicides, or other chemicals, in a concentration of from about 0.000001% of the formulation to about 90% (v/v or w/v) of the formulation or about 0.00001% to about 80%, 0.0001% to about 70%, about 0.001% to about 60%, about 0.01% to about 50%, about 0.1% to about 40%, about 0.05% to about 30%, about 0.1% to about 20%, or about 0.5% to about 10%.

In another embodiment, the formulation comprises the compound dissolved in water, organic solvents, or a mixture thereof, with other fertilizers, pesticides, herbicides, or other chemicals present, wherein the compound is present in less than 5% weight percent of the formulation. In another embodiment, the formulation comprises the compound dissolved in water, organic solvents, or a mixture thereof, with other fertilizers, pesticides, herbicides, or other chemicals present, wherein the compound is present in less than 1% weight percent of the formulation.

In other embodiments, the composition can be placed in containers of appropriate size, taking into consideration, for example, the intended use, the contemplated method of application, and any mode of transportation to the location of use. Thus, the containers into which the composition is placed may be, for example, from 1 pint to 10,000 gallons or more.

In certain embodiments, the compound or any combination thereof can be stored or transported in a composition at a concentration of about 0.001% to about 10%. In certain embodiments, the compound or any combination thereof can be stored or transported in a composition at a concentration of about 1% to about 100% and is intended to be diluted before application to a plant or soil.

Methods of Modulating Plant and/or Fungus Responses or Growth

In certain embodiments, the subject invention provides methods of modulating plant and/or fungal responses and/or growth, wherein a plant, a fungus and/or soil is treated with a composition comprising compounds of the subject invention.

In certain embodiments application of the composition to a plant, a fungus, or to its surrounding environment can, for example, alter or delay development of a plant and/or fungal tissue, alter or delay response to abiotic stress, environmental signal or infection in a plant and/or fungus, alter the flavor chemical profile of plant and/or fungal tissues, desiccate a crop to assist in harvest, and/or kill a plant and/or fungus.

In specific embodiments the subject invention provides methods for pre-harvest desiccation. The crop can be, for example, a grain. In specific embodiments, the crop can be, for example, wheat, oats, barley, camelina, and other small grains, as well as pulses (e.g., lentils, dry beans, dry peas and chickpeas).

In specific embodiments, gamma-undecalactone and/or gamma-decalactone are used for pre-harvest desiccation of grains.

As used herein, “applying” a composition or product to a site refers to contacting a composition or product with a site such that the composition or product can have an effect on that site. The mode of application depends upon the formulation of the composition, and can include, for example, spraying, pouring, sprinkling, injecting, spreading, mixing, dunking, fogging, dripping, and misting. Formulations can include, for example, liquids, dry and/or wettable powders, flowable powders, dusts, granules, pellets, emulsions, microcapsules, gels, pastes and/or aerosols. In an exemplary embodiment, the composition is applied after the composition has been prepared by, for example, mixing the composition with water.

In one embodiment, the site to which the composition is applied is the soil in which plants or fungi will be planted or are growing (e.g., a crop, a field, an orchard, a grove, a pasture/prairie or a forest). The compositions of the subject invention can be pre-mixed with irrigation fluids, wherein the compositions percolate through the soil and can be delivered to, for example, the soil. Alternatively, the compositions can be applied aerially. In one embodiment, the compositions are applied to soil surfaces, with or without water, where the beneficial effect of the soil application can be activated by rainfall, sprinkler, flood, or drip irrigation. The subject invention composition can be contacted to any plant tissue, such as, for example, the primary root, secondary root, stems, leaves, fruits, flowers, or seeds.

In certain embodiments, the crops can be treated in situ. In other embodiments, the crops can be relocated to a lab, or other site, in order to be treated with the compounds. In some embodiments, the plants being treated can be crops, which are grown and harvested for profit or subsistence. In other embodiments, the subject invention can be applied to foliage plants, angiosperms (flowering plants), mosses, liverworts, gymnosperms (conifers), and ferns. In one embodiment the composition is applied to a tract of land, such as farmland, pastureland, rangeland, forest land, or tracts cleared by natural fire and prescribed burns.

The methods and compositions of the subject invention can be used either alone or in combination with additional components, such as herbicides, fertilizers, pesticides and/or other soil amendments. Preferably, the additional components are non-toxic and environmentally-friendly. The exact materials and the quantities thereof can be determined by, for example, a grower or soil scientist having the benefit of the subject disclosure.

The methods of the subject invention can utilize standard methods and equipment that are used for maintenance of farmland or other soil. For example, the soil treatment composition can be applied in liquid form using an irrigation system. The composition can also be applied as a granule, as a coating (e.g., seed coating), or impregnated into prills. Additionally, the composition can be applied using a manual spreader, such as a broadcast spreader, a drop spreader, a handheld spreader, or a handheld sprayer. The composition can also be applied using aerial spreading (e.g., crop dusting), by, for example, airplane, helicopter, or drone.

Plants and/of fungi can be exposed to the subject compounds that can be formulated as pellets, capsules, sprays, mixed in water from the irrigation, added to waxes, paints or released from tanks, canisters, and even mounted on unmanned autonomous vehicles that are ariel or on the ground.

The compounds may be delivered with water or as a neat liquid, solid or solution. The compounds may be sprayed into soil at the time of planting, sprayed into soil at intervals post emergence, or sprayed on the foliage of a plant. In addition, the compounds may be applied to seeds prior to planting using established methods. For example, they may be coated on seeds with an inert vehicle, tumbled, and dried.

The compounds can be applied to soil, plants or fungi at any acceptable rate. For example, the compounds can be applied at a rate of at least about 1 kg per acre, at least about 2 kg per acre, at least about 5 kg per acre, at least about 10 kg per acre, or at least about 20 kg per acre, although higher application rates are not excluded.

In certain embodiments, the subject compositions can be stored at about 1° C. to about 37° C. or about 5° C. to about 25° C. In preferred embodiments, the plants and/or fungi are treated and grown at a temperature between about 5° C. to about 25° C. In other embodiments, the plants and/or fungi can be grown and treated at a temperature of about −10° C. to about 45° C.

In certain embodiments, the methods of the subject invention further comprise:
i) identifying a plant and/or fungal tissue in need of altering or delaying development of a plant and/or fungal tissue, altering or delaying response to an abiotic stress, an environmental signal or an infection in a plant and/or fungus, altering the flavor chemical profile of the plant and/or fungal tissue, desiccating the crop or death,
ii) examining the plant after administration of the compound to determine if plant and/or fungal tissue development, the response to an abiotic stress or infection, or the flavor chemical profile of the plant and/or fungal tissue has been altered or delayed, or the plant and/or fungus has died; optionally
iii) examining the plant and/or fungus to determine if the administration of the compound has inhibited HDAC; and, optionally
iv) measuring the amount of said compound in the air or soil around said plant and/or fungus.

In some embodiments, the systems of the subject invention further involve the monitoring of various inputs and outputs of crop production. For example, following application of a composition to a tract of land, factors such as water usage, soil moisture content and dispersion, fertilizer usage, soil salinity, soil nutrient content and dispersion, and plant growth, health and yields can be monitored. Accordingly, the composition can be adjusted throughout implementation to account for changes in these factors and make appropriate adjustments to the inputs of the subject compositions.

In certain embodiments, the compositions and methods of the subject invention can be used to control a pest plant, for example, a weed plant. In some embodiments, the compositions of the subject invention can function as an herbicide when applied to a plant (whether considered a pest plant or otherwise) with the intention of controlling, or killing, the plant.

In certain embodiments, the compositions and methods of the subject invention can be used to control a pest fungus, for example, an agriculturally pathogenic fungus. In some embodiments, the compositions of the subject invention can function as a fungicide when applied to a fungus (whether considered a pest fungus or otherwise) with the intention of controlling, or killing, the fungus.

In certain embodiments, the compositions of the subject invention can be used to alter or delay development of plant and/or fungal tissue, alter or delay a plant's and/or fungus' response to abiotic stress, environmental signal or infection, alter the flavor chemical profile of plant and/or fungal tissue, or alter the level of fructose, sorbitol, sucrose, fructose, glucose, malate, tartarate, or a flavor chemical profile or metabolite profile of plant and/or fungal tissue.

In certain embodiments, the flavor chemical is an aldehyde, such as, for example, 2-methylpropanal, butanal, 3-methylbutanal, 2-methylbutanal, 2-methyl-2-butenal, cis-3-hexenal, hexanal, trans-2-hexenal, heptanal, trans, trans-2,4-hexadienal, benzaldehyde, octanal, or nonanal; a hydrocarbon, such as, for example, cymene, limonene, terpinolene, undecane, dodecane, or tridecane; an alcohol, such as, for example, 2-methylpropanol, 3-methylbutanol, 2-methylbutanol, 4-methylpentanol, or 3-methylpentanol; a ketone, such as, for example, acetone, 1-penten-3-one, 6-methyl-5-hepten-2-one, or geranyl acetone; an oxygen-containing heterocyclic compound, such as, for example, 2-methylfuran, or 2-ethyl furan; an ester, such as, for example, butyl acetate, 2-methylbutyl acetate, or methyl salicylate; a nitrogen compound, such as, for example, 1-nitro-pentane; or a sulfur- and nitrogen-containing heterocyclic compound, such as, for example, 2-isobutylthiazole, or 1-nitro-2-phenylethane.

In certain embodiments, the metabolite is, for example, acetaldehyde, ethyl butanoate, ethyl methyl propanoate, 2-methyl butanol, ethyl 2-methyl butanoate, 2-methyl butyl acetate, hexyl acetate, butyl acetate, hexyl butanoate, hexyl hexanoate, €-2-hexenal, (Z)-2-hexenal, acetoin, 2,3-butanediol, solerol, hexanal, isoamyl acetate, 3-methylbutyl acetate, 3-methylbutyl butanoate, benzaldehyde, (E)-2-hexen-1-ol, limonene, β-myrcene, linalool, geraniol, phenylethyl alcohol, octanoic acid, terpinol, nerolidol, beta-damascenone, beta-iononone, or S-3-(hexane-1-ol-L-cysteine).

In certain embodiments, the flavor or fragrance composition contains one or more of the compounds of a fruit, food, flower, spice, etc. In some embodiments, the flavor is associated with a natural flavor from one or more substances, for example, almond, anise/licorice, aromatic, banana, cantaloupe/honeydew, cedarwood, cherry/berry, cinnamon, clove, coconut, coffee, cologne, flower, fragrance, fresh tobacco/smoke, fruit/citrus, fruit other than citrus, garlic/onion, geranium leaves, herbal green/cut grass, incense, lavender, leather, lemon, medicine, mint/peppermint, musk, oak wood/cognac, orange, peach fruit, pear, perfume, pineapple, rose, soap, spice, strawberry, sweet, vanilla, violets, woody resins, and combinations thereof. In some embodiments, the flavor composition or fragrance composition contains one or more of the compounds described herein which impart cooling sensation along or together with other compounds identified there in and/or components known in the art.

In certain embodiments, the fragrance contains one or more of the compounds described herein which have an order that reminds a fruit, food, flower, spice, etc. Examples of plant made fragrances include, but are not limited to, rose, jasmine, frangipani, tuberose, lilac, sandalwood, lemon, myrrh, anise, cinnamon, vanilla, cardamon, lemon grass, lemon balm, mint, citrus, sweet woodruff, angelica, and a variety of flowers, leaves, fruits, roots, and seeds.

In certain embodiments, the fragrance or flavor compound is, for example, geranyl acetate, methyl butyrate, methyl butanoate, ethyl acetate, ethyl butyrate, ethyl butanoate, isoamyl acetate, pentyl butyrate, pentyl butanoate, pentyl pentanoate, octyl acetate, benzyl acetate, methyl anthranilate, methyl salicylate, hexyl acetate, myrcene, geraniol, nerol, citral, lemonal, geranial, neral, citronellal, citronellol, linalool, nerolidol, ocimene, limonene, camphor, menthol, carvone, terpineol, alpha-ionone, thujone, eucalyptol, jasmone, benzaldehyde, eugenol, cinnamaldehyde, vanillin, anisole, anethole, estragole, or thymol.

In certain embodiments, compounds that contribute to the fragrance or flavor are, for example, isothiocyanates, nitriles, epithionitriles, thiols, sulfides, polysulfides, sulfur containing carbonyl compounds and esters, R-L-cysteine sulfoxides, heterocyclic sulfur compounds, and any combination thereof.

In some embodiments, the fragrance production can be altered by using the subject compositions with other methods well known in the art, such as, for example, using drip irrigation, avoiding pesticides and chemical fertilizers, and balancing and layering the soil/medium where the plants and/or fungi are growing.

In certain embodiments, the subject methods can delay the growth or killing a plant or fungus, particularly a plant or a fungus that is infected with a virus, fungus, and/or bacterium; infested by insects; or any combination thereof. In certain embodiments, the subject methods can alter a response to a growth signal in a plant or fungus, such as, for example, delaying or accelerating a growth stage. In certain embodiments, the subject invention can be contacted to plants or fungi undergoing abiotic stressors, such as, for example, high salt, excessive cold temperatures, excessive hot temperatures, flooding, drought, wind, heavy metals exposure, ultraviolet radiation, elevation, or any combination thereof.

In some embodiments, the infection can be a fungal infection, including, for example, by Pseudoperonospora cubensis; a bacterial infection, including, for example, by Candidatus Liberibacter spp., Pseudomonas spp., or Xanthomonas spp.; or a viral infection, including, for example, by a mosaic virus, or any combination thereof. In certain embodiments, the insect is, for example, an aphid, scale insect, whitefly, mite (e.g., red spider mite), mealybug, thrip, leaf miner, earwig, leafhopper, caterpillar, gastropod, slug, beetle (e.g., Japanese beetle, flea beetle), springtail, ant, weevil (e.g., vine weevil), stink bug (e.g., brown marmorated stink bug), or any combination thereof.

In certain embodiments, the subject invention can be applied to plants and/or fungi undergoing abiotic stressors, such as, for example, high salt, excessive cold temperatures, excessive hot temperatures, flooding, drought, wind, heavy metals exposure, high elevation, ultraviolet radiation or any combination thereof.

In certain embodiments, the abiotic stress can be a high concentration of salt in the soil, such as, for example, at least about 250 ppm, about 500 ppm, about 750 ppm, about 1,000 ppm, about 1,500 ppm, about 2,000 ppm, about 2,500 ppm, about 5,000 ppm, about 10,000 ppm or higher.

In certain embodiments, excessive cold temperatures can be less than about 5° C., about 0° C., about −5° C., or about −10° C.

In certain embodiments, excessive hot temperatures can be more than about 35° C., about 40° C., about 45° C., or about 50° C.

In certain embodiments, the elevation is at least about 4000 feet, about 5000 feet, about 6000 feet, about 7000 feet, about 8000 feet, about 9000 feet, about 10000 feet, about 11000 feet, about 12000 feet, about 13000 feet, about 14000 feet, or about 15000 feet above sea level.

In certain embodiments, the compositions and methods of the subject invention can be applied to plants and/or fungi to alter a response to an environmental signal such as, for example, day length, light exposure, temperature, water availability, nutrient availability, carbon dioxide, pollination, reactive oxygen species, gravity, wind, touch (mechanical influences) or chemical influences. The altered response can include, for example, phototropism, gravitropism, thigmotropism, hydrotropism, thigmomorphogenesis, altered circadian rhythms (e.g., temperature and day length-mediated flowering, bolting and fruiting), root growth, gene and protein expression, hormone production, dormancy, and leaf abscission.

In certain embodiments, the environmental signal is an increase or a decrease in the amount of access to sunlight by at least about 30 minutes to 12 hours, 60 minutes to 8 hours, 90 minutes to 4 hours, or 2 hours to 3 hours.

In certain embodiments, the environmental signal is an increase or a decrease in temperature by at least about 0.1 to 30° C., about 1 to 20° C., or about 5 to 10° C.

In certain embodiments, the subject compositions and methods can alter the water content of the plant or fungus. In preferred embodiments, the subject compositions can be applied to the target plant or fungus to decrease the amount of water in the tissue of the organism (i.e., desiccate the tissue). In certain embodiments, the composition can be applied to the plant or fungus while the plant or fungus is growing, or the composition can be applied during or after harvesting of the plant or fungus. In certain embodiments, the subject composition can be used to desiccate a seed of a plant or a spore of a fungus. In certain embodiments, the composition can decrease the amount of water in the tissue of the plant or fungus by at least about 2.5%, about 5%, about 10%, about 15%, about 20%, about 25%, about 37.5%, or about 50%.

In some embodiments, the subject compositions can alter the production of compounds for medicinal use. In some embodiments, the medicinal compounds can be cannabinoids, such as, for example, tetrahydrocannabinol (THC), cannabidiol (CBD), or cannabinol (CBN); minerals, such as sulfur, magnesium, potassium, manganese, and calcium; alkaloids; glycosides; polyphenols; or terpenes. Alkaloids are found in several different pharmaceutical classes, such as, atropine, scopolamine, hyoscyamine, berberine, caffeine, cocaine, ephedrine, morphine, nicotine, reserpine, quinidine, quinine, vincamine, and vincristine. Glycosides can be found in plant-based laxatives, such as those made from senna, rhubarb, and aloe. Glycosides can also be in medications used for cardiac purposes. Polyphenols can be used to treat gynecological disorders. Terpenes and terpenoids can be used in essential oils, perfumes, and for aromatherapy. The compositions and methods of the subject invention can increase or decrease the amount of these compounds that are produced by the plants. In some embodiments, the subject methods can increase or decrease the amount of useful compounds produced by about 5% to about 100%.

In some embodiments, the compounds for medicinal use can be produced by fungi. Examples of medicinal compounds from fungi include, for example, polysaccharide peptides, ergosterol, inotodiol, beta-glucan, ganoderic acid, lentinan, grifolin, cordycepin, hispolon, and psilocybin. The compositions and methods of the subject invention can increase or decrease the amount of these compounds that are produced by the fungi. In some embodiments, the subject methods can increase or decrease the amount of useful compounds produced by about 5% to about 100%.

In certain embodiments, the compounds synthesized, growth rates, and/or other phenotype changes can be monitored before, during, and/or after applying the compositions of the subject invention to a fungus, plant, or environment of the fungus or plant. Methods of monitoring these changes include sampling the plants and/or fungi, measuring compounds, and measuring phenotype changes.

In certain embodiments, the plant and/or fungus can be sampled by cutting, sectioning, or any other method of fragmenting the plant and/or fungus. In some embodiments, a fungus is sampled by collecting the major parts of the fungus, such as, for example, the cap, gills, stem, and base, or a plant is sampled by collecting, for example, a primary root, secondary root, leaf, stem, fruit, flower, or seed. In some embodiments, the plant and/or fungus collection can be done at one time or over period of time, such as, from about one second to about one year.

In some embodiments, the compounds can be measured using methods such as, for example, gas chromatography-mass spectrometry (GC/MS) and/or liquid chromatography-mass spectrometry (LC/MS).

In certain embodiments, phenotype changes can be observed or measured, including for example, color, weight, length, or morphology of a plant or fungus. In certain embodiments, phenotype changes are measured using a spectrophotometer or by observing or measuring changes of sizes or weights of parts of the fungus or plant. In some embodiments, the optical density of a sample can be measured over the IR range at about 700 to about 15,000 nanometers. In certain embodiments, the measurements can be taken at repeating time intervals, for example, daily, once a week, once a month, once a year, or any interval in between.

Advantageously, the methods and compositions of the subject invention can increase the efficiency and reduce the financial and environmental costs of agriculture practices.

### Target Plants

As used here, the term “plant” includes, but is not limited to, any species of woody, ornamental or decorative, crop or cereal, fruit plant or vegetable plant, flower or tree, macroalga or microalga, phytoplankton and photosynthetic algae (e.g., green algae Chlamydomonas reinhardtii). “Plant” also includes a unicellular plant (e.g., microalga) and a plurality of plant cells that are largely differentiated into a colony (e.g., volvox) or a structure that is present at any stage of a plant's development. Such structures include, but are not limited to, a fruit, a seed, a shoot, a stem, a leaf, a root, a flower petal, etc. Plants can be standing alone, for example, in a garden, or can be one of many plants, for example, as part of an orchard, crop or pasture.

The target plants can either be plants that are weeds, or plants to be protected from weeds and other unwanted vegetation, or they can be crop plants that derive an agriculture benefit from treatment with a composition of the subject invention. This agriculture benefit can be, for example, desiccation, defoliation or improved harvesting of fruit or nuts.

In certain embodiments, the compositions and/or methods of the subject invention are used during a growing season. In these embodiments, the compositions and methods can first be determined to have no, or an acceptably low, deleterious impact on the desired plant(s).

Alternatively, or additionally, the compositions and methods can be applied in a targeted manner to avoid or reduce exposure of the desired plants to the compositions and methods.

Examples of plants for which the subject invention is useful include, but are not limited to, cereals and grasses (e.g., wheat, barley, rye, oat, rice, maize, sorghum, corn, millet, triticale, turf, pasture grass), beets (e.g., sugar or fodder beets); fruit (e.g., grapes, strawberries, raspberries, blackberries, pomaceous fruit, stone fruit, soft fruit, apples, pears, plums, peaches, almonds, cherries or berries); leguminous crops (e.g., beans, lentils, peas or soya); oil crops (e.g., oilseed rape, mustard, poppies, olives, sunflowers, coconut, castor, cocoa or ground nuts); cucurbits (e.g., pumpkins, cucumbers, squash or melons); fiber plants (e.g., cotton, flax, hemp or jute); citrus fruit (e.g., oranges, lemons, grapefruit or tangerines); vegetables (e.g., spinach, lettuce, asparagus, cabbages, broccolis, carrots, onions, tomatoes, potatoes or bell peppers); Lauraceae (e.g., avocado, Cinnamonium or camphor); and also tobacco, nuts, herbs, spices, medicinal plants, coffee, eggplants, sugarcane, tea, pepper, grapevines, hops, the plantain family, latex plants, cut flowers and ornamentals.

Further types of plants that can benefit from application of the products and methods of the subject invention include, but are not limited to: row crops (e.g., corn, soy, sorghum, peanuts, potatoes, etc.), field crops (e.g., alfalfa, wheat, grains, etc.), tree crops (e.g., walnuts, almonds, pecans, hazelnuts, pistachios, etc.), citrus crops (e.g., orange, lemon, grapefruit, etc.), fruit crops (e.g., apples, pears, strawberries, blueberries, blackberries, etc.), turf crops (e.g., sod), ornamentals crops (e.g., flowers, vines, etc.), vegetables (e.g., tomatoes, carrots, etc.), vine crops (e.g., grapes, etc.), forestry (e.g., pine, spruce, eucalyptus, poplar, etc.), managed pastures (any mix of plants used to support grazing animals).

Further plants that can benefit from the products and methods of the invention include all plants that belong to the superfamily Viridiplantae, in particular monocotyledonous and dicotyledonous plants including fodder or forage legumes, ornamental plants, food crops, trees or shrubs selected from Acer spp., Actinidia spp., Abelmoschus spp., Agave sisalana, Agropyron spp., Agrostis stolonifera, Allium spp., Amaranthus spp., Ammophila arenaria, Ananas comosus, Annona spp., Apium graveolens, Arachis spp, Artocarpus spp., Asparagus officinalis, Avena spp. (e.g., A. sativa, A. fatua, A. byzantina, A. fatua var. sativa, A. hybrida), Averrhoa carambola, Bambusa sp., Benincasa hispida, Bertholletia excelsea, Beta vulgaris, Brassica spp. (e.g., B. napus, B. rapa ssp. [canola, oilseed rape, turnip rape]), Cadaba farinosa, Camellia sinensis, Cannabis indica, Cannabis sativa, Cannabis ruderalis, Capsicum spp., Carex elata, Carica papaya, Carissa macrocarpa, Carya spp., Carthamus tinctorius, Castanea spp., Ceiba pentandra, Cichorium endivia, Cinnamomum spp., Citrullus lanatus, Citrus spp., Cocos spp., Coffea spp., Colocasia esculenta, Cola spp., Corchorus sp., Coriandrum sativum, Corylus spp., Crataegus spp., Crocus sativus, Cucurbita spp., Cucumis spp., Cynara spp., Daucus carota, Desmodium spp., Dimocarpus longan, Dioscorea spp., Diospyros spp., Echinochloa spp., Elaeis (e.g., E. guineensis, E. oleifera), Eleusine coracana, Eragrostis tef, Erianthus sp., Eriobotrya japonica, Eucalyptus sp., Eugenia uniflora, Fagopyrum spp., Fagus spp., Festuca arundinacea, Ficus carica, Fortunella spp., Fragaria spp., Ginkgo biloba, Glycine spp. (e.g., G. max, Soja hispida or Soja max), Gossypium hirsutum, Helianthus spp. (e.g., H. annuus), Hemerocallis fulva, Hibiscus spp., Hordeum spp. (e.g., H. vulgare), Ipomoea batatas, Juglans spp., Lactuca sativa, Lathyrus spp., Lens culinaris, Linum usitatissimum, Litchi chinensis, Lotus spp., Luffa acutangula, Lupinus spp., Luzula sylvatica, Lycopersicon spp. (e.g., L. esculentum, L. lycopersicum, L. pyriforme), Macrotyloma spp., Malus spp., Malpighia emarginata, Mammea americana, Mangifera indica, Manihot spp., Manilkara zapota, Medicago sativa, Melilotus spp., Mentha spp., Miscanthus sinensis, Momordica spp., Morus nigra, Musa spp., Nicotiana spp., Olea spp., Opuntia spp., Ornithopus spp., Oryza spp. (e.g., O. sativa, O. latifolia), Panicum miliaceum, Panicum virgatum, Passiflora edulis, Pastinaca sativa, Pennisetum sp., Persea spp., Petroselinum crispum, Phalaris arundinacea, Phaseolus spp., Phleum pratense, Phoenix spp., Phragmites australis, Physalis spp., Pinus spp., Pistacia vera, Pisum spp., Poa spp., Populus spp., Prosopis spp., Prunus spp., Psidium spp., Punica granatum, Pyrus communis, Quercus spp., Raphanus sativus, Rheum rhabarbarum, Ribes spp., Ricinus communis, Rubus spp., Saccharum spp., Salix sp., Sambucus spp., Secale cereale, Sesamum spp., Sinapis sp., Solanum spp. (e.g., S. tuberosum, S. integrifolium or S. lycopersicum), Sorghum bicolor, Spinacia spp., Syzygium spp., Tagetes spp., Tamarindus indica, Theobroma cacao, Trifolium spp., Tripsacum dactyloides, Triticosecale rimpaui, Triticum spp. (e.g., T aestivum, T. durum, T turgidum, T. hybernum, T. macha, T. sativum, T. monococcum or T vulgare), Tropaeolum minus, Tropaeolum majus, Vaccinium spp., Vicia spp., Vigna spp., Viola odorata, Vitis spp., Zea mays, Zizania palustris, Ziziphus spp., amongst others.

Further examples of plants of interest include, but are not limited to, corn (Zea mays), Brassica sp. (e.g., B. napus, B. rapa, B. juncea), particularly those Brassica species useful as sources of seed oil, alfalfa (Medicago sativa), rice (Oryza sativa), rye (Secale cereale), sorghum (Sorghum bicolor, Sorghum vulgare), millet (e.g., pearl millet (Pennisetum glaucum), proso millet (Panicum miliaceum), foxtail millet (Setaria italica), finger millet (Eleusine coracana)), sunflower (Helianthus annuus), safflower (Carthamus tinctorius), wheat (Triticum aestivum), soybean (Glycine max), tobacco (Nicotiana tabacum), potato (Solanum tuberosum), peanuts (Arachis hypogaea), cotton (Gossypium barbadense, Gossypium hirsutum), sweet potato (Ipomoea batatus), cassava (Manihot esculenta), coffee (Coffea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), sugar beets (Beta vulgaris), sugarcane (Saccharum spp.), oats, barley, vegetables, ornamentals, and conifers.

Vegetables include tomatoes (Lycopersicon esculentum), lettuce (e.g., Lactuca sativa), green beans (Phaseolus vulgaris), lima beans (Phaseolus limensis), peas (Lathyrus spp.), and members of the genus Cucumis such as cucumber (C. sativus), cantaloupe (C. cantalupensis), and musk melon (C. melo). Ornamentals include azalea (Rhododendron spp.), hydrangea (Macrophylla hydrangea), hibiscus (Hibiscus rosasanensis), roses (Rosa spp.), tulips (Tulipa spp.), daffodils (Narcissus spp.), petunias (Petunia hybrida), carnation (Dianthus caryophyllus), poinsettia (Euphorbia pulcherrima), and chrysanthemum. Conifers that may be employed in practicing the embodiments include, for example, pines such as loblolly pine (Pinus taeda), slash pine (Pinus elliotii), ponderosa pine (Pinus ponderosa), lodgepole pine (Pinus contorta), and Monterey pine (Pinus radiata); Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and Alaska yellow-cedar (Chamaecyparis nootkatensis). Plants of the embodiments include crop plants (for example, corn, alfalfa, sunflower, Brassica, soybean, cotton, safflower, peanut, sorghum, wheat, millet, tobacco, etc.), such as corn and soybean plants.

Turfgrasses include, but are not limited to: annual bluegrass (Poa annua); annual ryegrass (Lolium multiflorum); Canada bluegrass (Poa compressa); Chewings fescue (Festuca rubra); colonial bentgrass (Agrostis tenuis); creeping bentgrass (Agrostis palustris); crested wheatgrass (Agropyron desertorum); fairway wheatgrass (Agropyron cristatum); hard fescue (Festuca longifolia); Kentucky bluegrass (Poa pratensis); orchardgrass (Dactylis glomerate); perennial ryegrass (Lolium perenne); red fescue (Festuca rubra); redtop (Agrostis alba); rough bluegrass (Poa trivialis); sheep fescue (Festuca ovine); smooth bromegrass (Bromus inermis); tall fescue (Festuca arundinacea); timothy (Phleum pretense); velvet bentgrass (Agrostis canine); weeping alkaligrass (Puccinellia distans); western wheatgrass (Agropyron smithii); Bermuda grass (Cynodon spp.); St. Augustine grass (Stenotaphrum secundatum); zoysia grass (Zoysia spp.); Bahia grass (Paspalum notatum); carpet grass (Axonopus affinis); centipede grass (Eremochloa ophiuroides); kikuyu grass (Pennisetum clandesinum); seashore paspalum (Paspalum vaginatum); blue gramma (Bouteloua gracilis); buffalo grass (Buchloe dactyloids); sideoats gramma (Bouteloua curtipendula).

Plants of interest include grain plants that provide seeds of interest, oil-seed plants, and leguminous plants. Seeds of interest include grain seeds, such as corn, wheat, barley, rice, sorghum, rye, millet, etc. Oil-seed plants include cotton, soybean, safflower, sunflower, Brassica, maize, alfalfa, palm, coconut, flax, castor, olive etc. Leguminous plants include beans and peas. Beans include guar, locust bean, fenugreek, soybean, garden beans, cowpea, mungbean, lima bean, fava bean, lentils, chickpea, etc.

Further plants of interest include Cannabis (e.g., sativa, indica, and ruderalis) and industrial hemp.

### EXAMPLES

It should be understood that the examples and embodiments described herein are for illustrative purposes only and that various modifications or changes in light thereof will be suggested to persons skilled in the art and are to be included within the spirit and purview of this application.

### Example 1—Herbicide Study

Compounds according to embodiments of the subject invention were tested on four potted weed plants:
1. Green Foxtail (Setaria viridis)
2. Large Crabgrass (Digitaria sanquinalis)
3. Lambs quarter (Chenopodium album)
4. Palmer Amaranth (Amaranthus palmeri).

Plant seeds were planted and allowed to germinate and establish in 4-inch plastic pots with clear plastic vented domes.

Potted plants were sprayed with 1 mL of 3% or 1% of test compound diluted in water containing a standard surfactant using a spray bottle. Each pot was covered with clear plastic vented hoods. On day 7 all the hoods were removed, and observations were taken. Pots were watered twice/week for 15 minutes by bottom watering method, allowing water to be slowly absorbed and drawn into the potting soil. Each plant was always watered from its own individual saucer throughout the period of the observation to minimize any cross contamination by material in soil water residues in the plastic saucers.

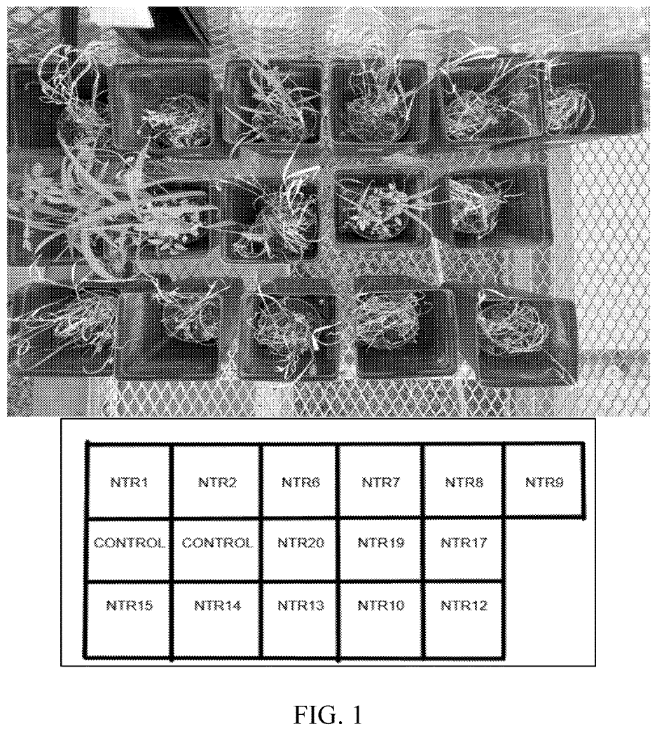

Results are reported in Table 3 and in FIG. 1.

TABLE 3
Tested herbicide compounds and their plant killing effects

| Reference | | Plant Killing |
|---|---|---|
| Code | Compound Name | Day 14 (3%) |
| NTR14 | Gamma-undecalactone | [++++] |
| NTR11 | Gamma-hexalactone | [++++] |
| NTR9 | Gamma-decalactone | [++++] |
| NTR2 | Cinnamaldehyde | [++++] |
| NTR10 | Gamma-dodecalactone | [++++] |
| NTR8 | Cuminyl formate | [++++] |
| NTR12 | Gamma-octalactone | [++++] |
| NTR17 | Ethyl cinnamate | [+++] |
| NTR1 | Citral | [++++] |
| NTR20 | Delta-decalactone | [+++] |
| NTR13 | Gamma-nonalactone | [+++] |
| NTR15 | Geranyl formate | [+++] |
| NTR7 | Citronellyl formate | [++] |
| NTR6 | Cyclohexyl formate | [+] |
| NTR19 | Linalyl formate | [+] |

### Example 2

In one embodiment, the subject invention provides a herbicidal composition comprising linoleic acid (HACT-7) and wintergreen oil (HINT-7). Preferably, each is at a concentration of greater than 1% and, most preferably, they are each at a concentration of 3% to 10%. Optionally, the composition can further comprise cinnamaldehyde and/or eugenol. This composition has been found to have excellent herbicidal activity.

We claim:

1. A method for altering growth and/or health of a plant and/or fungus, wherein the method comprises applying to the plant, the fungus and/or to soil, a compound having a structure according to any of General Formulas (1) to (20), and wherein the method alters the growth and/or health of the plant and/or fungus via:
a) killing the plant and/or fungus;
b) desiccating the plant and/or fungus by altering a water content in the plant and/or fungus;
c) altering or delaying development of a tissue in the plant and/or fungus;
d) altering a flavor chemical profile of the plant and/or fungal tissue;
e) altering or delaying response to an abiotic stress, an environmental signal, an infection, or an infestation in the plant and/or fungus;
f) germinating a seed or a bulb; and/or
g) enhancing growth of a graft of the plant.

2. The method of claim 1, wherein the compound is a lactone or formate according to General Formula (1) to (6).

3. The method of claim 2, wherein the lactone is a gamma lactone selected from the group consisting of gamma-dodecalactone, gamma-undecalactone, gamma-hexalactone, gamma-decalactone, gamma-valerolactone, gamma-butyrolactone, gamma-octalactone and gamma-nonalactone.

4. The method of claim 2, wherein the lactone is a delta lactone selected from the group consisting of delta-decalactone, delta-octalactone, delta-hexalactone and delta-undecalactone.

5. The method of claim 1, wherein the composition is applied as dry granules.

6. The method of claim 1, wherein the plant is a crop, foliage plant, angiosperm, moss, liverwort, gymnosperm, or fern.

7. The method of claim 1, used to kill a weed.

8. The method of claim 7, wherein the weed is selected from Poison sumac (Toxicodendron vernix), Japanese knot weed (Polygonum cuspidatum), crabgrass (Digitaria spp.), dandelions (Taraxaum spp.), broadleaf plantain (Plantago major), common ragweed (Ambrosia artemisiifolia), giant ragweed (Abrosia trifida), bindweed (Convolvulus arvensis), ground ivy (Glechoma hederacea), purslane (Portulaca olearacea), stinging nettle (Urtica dioica), curly dock (Rumex crispus), bitter dock (Rumex obtusifolius) wild madder (Galium mollugo), clover leaf (Trifolium), orange jewelweed (Impatiens capensis), bittersweet (Celastrus spp.), horsetail weed (Equisetum arvense), chickweed (Stellaria media), Canada thistle (Cirsium arvense), annual sow thistle (Sonchus oleraceus), quackgrass (Elymus repens), Shepherd's Purse (Capsella bursa-pastoris), woodsorrel (Oxalis stricta), common mallow (Malva neglecta), lambsquarters (Chenopodium album), pigweed (Amaranthus retroflexus), nutsedge (Cyperus spp.), dayflower (Commelina spp.), velvetleaf (Abutilon theophrasti), wild violet (Viola papilionacea), smartweed (Polygonum pensylvanicum), quickweed (Galinsoga parviflora), pokeweed (Phytolacca americana), black nightshade (Solanum nigrum), black medic (Medicago lupulina), poison ivy (Rhus radicans), burdock (Arctium spp.), common groundsel (Senecio vulgaris), curly dock (Rumex crispus), spurge (Euphorbia maculata), puncturevine (Tribulus terrestris), rough cinquefoil (Potentilla norvegica), sandbur (Cenchrus spp.), sheep sorrel (Rumex acetosella), Bermuda grass (Cynodon dactylon), common daisy (Bellis perennis L.), common self-heal (Prunella vulgaris L.), creeping buttercup (Ranunculus repens), doveweed (Murdannia nudiflora), flatweed (Hypochaeris radicata), ground elder (Aegopodium podagraria), herb bennet (Geum urbanum), or marestail (Conyza canadensis).

9. The method of claim 1, wherein the weed is Green Foxtail or Palmer Amaranth.

10. The method of claim 1, used to desiccate a crop prior to harvesting the crop.

11. The method of claim 10, wherein the crop is a grain crop.

12. The method according to claim 10, wherein the compound is a delta lactone or a gamma lactone.

13. The method according to claim 12, wherein the lactone is gamma-undecalactone or gamma-decalactone.

14. The method according to claim 13, wherein the crop is a grain crop.

15. The method of claim 1, wherein the monitoring the flavor or medicinal chemical profile of the plant comprises monitoring the chemical profile of a fruit, vegetable, leaf, tuber, or root.

16. The method of claim 1, wherein the composition is applied to soil using an irrigation system, drip system, aerial sprayer, or a ground application method.

17. The method of claim 1, wherein the compound is a compound selected from Table 1.

18. The method of claim 1, wherein the compound is a compound selected from Table 2.

19. A composition comprising linoleic acid and wintergreen oil.

20. A method for killing or desiccating a plant, wherein said method comprises applying to said plant a composition of claim 19.
